(19) United States
(12) Patent Application Publication
(10) Pub. No.: US 2025/0358901 A1
(43) Pub. Date: Nov. 20, 2025

(54) METHOD AND APPARATUS FOR CANCELLING IN-PROGRESS IMMINENT PERIL STATE OF THE GROUP WHILE CALL IS NOT ONGOING ON THE GROUP IN A COMMUNICATION SYSTEM

(71) Applicant: Samsung Electronics Co., Ltd., Suwon-si (KR)

(72) Inventors: Kiran Gurudev KAPALE, Bengaluru (IN); Arunprasath RAMAMOORTHY, Bengaluru (IN)

(21) Appl. No.: 19/213,217

(22) Filed: May 20, 2025

(30) Foreign Application Priority Data
May 20, 2024 (IN) 202441039248
May 5, 2025 (IN) 2024 41039248

(51) Int. Cl. H04W 76/45; H04L 65/1104; H04W 12/06; H04W 76/50

(52) U.S. Cl. CPC H04W 76/45; H04L 65/1104; H04W 12/06; H04W 76/50

(57) ABSTRACT

The disclosure relates to a 5G or 6G communication system for supporting a higher data transmission rate. A method performed by a mission critical push to talk (MCPTT) server for handling in-progress imminent peril state in a communication system is provided. The method includes receiving a session initiation protocol (SIP) request message transmitted from an MCPTT client of an MCPTT group to cancel an in-progress imminent peril state of the MCPTT group, wherein the SIP request message includes an imminent peril indication being set to false, setting the in-progress imminent peril state of the MCPTT group to a value of false, clearing all MCPTT identification (ID) of MCPTT users that triggered the setting of the in-progress imminent peril state of the MCPTT group to true, transmitting a SIP notification message including an imminent peril indication set to false for each of affiliated members of the MCPTT group, and transmitting a response to the SIP request message.

### CROSS-REFERENCE TO RELATED APPLICATION(S)

This application is based on and claims priority under 35 U.S.C. § 119 (a) of an Indian Provisional patent application No. 20/244,1039248, filed on May 20, 2024, in the Indian Intellectual Property Office, and of an Indian Complete patent application No. 202441039248, filed on May 5, 2025, in the Indian Intellectual Property Office, the disclosure of each of which is incorporated by reference herein in its entirety.

### BACKGROUND

### 1. Field

The disclosure relates to a telecommunication network. More particularly, the disclosure relates to cancelling in-progress imminent peril state of the group while call is not ongoing on the group.

### 2. Description of Related Art

Fifth generation (5G) mobile communication technologies define broad frequency bands such that high transmission rates and new services are possible, and can be implemented not only in “Sub 6 GHz” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In addition, the telecommunication industry has experienced continuous growth and development, leading to the increased importance of imminent peril calls for first responders. These calls typically include multiple participants communicating within a group, where one or more users may find themselves in a state of imminent peril requiring immediate assistance. Imminent peril communication in the mission critical services (MCS) are prioritized due to their role in operations. Mission critical services are defined as services so vital to an operation that any disruption or failure can disrupt the operation. These services are particularly relevant for public safety agencies, such as Police, Fire, and ambulance services, which rely on high reachability, availability, reliability, and quality of service to effectively respond to emergency situations.

Mission critical services are critical to operations because any disruption or failure in receiving data related to such services can be catastrophic, potentially leading to fatalities and significant property loss. For instance, in accordance with 3GPP TS 23.379, when a mission critical push to talk (MCPTT) user detects an imminent peril condition, an MCPTT client initiates an MCPTT imminent peril group call or upgrades an ongoing call to an imminent peril call for affiliated MCPTT members of that group. During such an event, the MCPTT group in the imminent peril state gains elevated access privileges for mission-critical applications, and the group remains in this state until it is explicitly cancelled.

The MCPTT server configures the priority of the underlying bearers for participants in the MCPTT group, ensuring that successive calls during the group's in-progress imminent peril state receive the adjusted bearer priority. However, the end of the MCPTT imminent peril group call does not automatically cancel the group's in-progress imminent peril state. Instead, it must be explicitly cancelled by an authorized user through a separate procedure. Currently, there is no defined procedure to handle the cancellation of the in-progress imminent peril state of the group when there is no ongoing call on the group.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for cancelling the in-progress imminent peril state of the group while a call is not ongoing in the group.

Another aspect of the disclosure is to handle multiple users' imminent peril conditions by caching imminent peril conditions of users and notifying affiliated members of the group of the imminent peril conditions of users and the in-progress imminent peril state of the group.

Another aspect of the disclosure is to provide the imminent peril indications to set or clear the imminent peril state of the group.

Additional aspects will be set forth in part in the description which follows and, in part, will be apparent from the description, or may be learned by practice of the presented embodiments.

In accordance with an aspect of the disclosure, a method performed by a mission critical push to talk (MCPTT) server for handling in-progress imminent peril state in a communication system is provided. The method includes receiving a session initiation protocol (SIP) request message transmitted from an MCPTT client of an MCPTT group to cancel an in-progress imminent peril state of the MCPTT group, wherein the SIP request message includes an imminent peril indication being set to false, setting the in-progress imminent peril state of the MCPTT group to a value of false, clearing all MCPTT identification (ID) of MCPTT users that triggered the setting of the in-progress imminent peril state of the MCPTT group to true, transmitting a SIP notification message including an imminent peril indication set to false for each of affiliated members of the MCPTT group, and transmitting a response to the SIP request message.

In accordance with another aspect of the disclosure, a method performed by a mission critical push to talk (MCPTT) client for handling in-progress imminent peril state in a communication system is provided. The method includes generating a SIP request message including an in-progress imminent peril state indication set to false to cancel in-progress imminent peril state of the MCPTT group upon receiving a request from an MCPTT user to cancel the in-progress imminent peril state of the MCPTT group, transmitting, to an MCPTT server, the SIP request message to cancel the in-progress imminent peril state of the MCPTT group, and receiving, from the MCPTT server, a response to the SIP request message.

In accordance with another aspect of the disclosure, an MCPTT server for handling in-progress imminent peril state in a communication system is provided. The MCPTT server includes a processor configured to receive a session initiation protocol (SIP) request message transmitted from an MCPTT client of a MCPTT group to cancel an in-progress imminent peril state of the MCPTT group, wherein the SIP request message includes an imminent peril indication being set to false, set the in-progress imminent peril state of the MCPTT group to a value of false, clear of all MCPTT IDs of MCPTT users that triggered the setting of the in-progress imminent peril state of the MCPTT group to true, transmit a SIP notification message including an imminent peril indication set to false for each of affiliated members of the MCPTT group, and transmit a response to the SIP request message.

In accordance with another aspect of the disclosure, an MCPTT client for handling in-progress imminent peril state in a communication system is provided. The MCPTT client includes a processor configured to generate a SIP request message including an in-progress imminent peril state indication set to false to cancel the in-progress imminent peril state of the MCPTT group upon receiving a request from an MCPTT user to cancel the in-progress imminent peril state of the MCPTT group, transmit, to an MCPTT server, the SIP request message to cancel the in-progress imminent peril state of the MCPTT group, and receive, from the MCPTT server, a response to the SIP request message.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications can be made within the scope of the embodiments herein.

According to embodiments of the disclosure, efficient communication can be achieved.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an MCPTT server for handling in-progress imminent peril state during mission-critical services according to an embodiment of the disclosure;

FIG. 2 is a block diagram of an MCPTT client for handling in-progress imminent peril state during mission-critical services according to an embodiment of the disclosure;

FIG. 3 is a flow diagram that illustrates a method for handling in-progress imminent peril state during mission-critical services by an MCPTT server according to an embodiment of the disclosure;

FIG. 4 is a flow diagram that illustrates a method for handling in-progress imminent peril state during mission-critical services by an MCPTT client according to an embodiment of the disclosure;

FIG. 5 is a sequence diagram that illustrates a procedure for canceling in-progress imminent peril state of a group while a call is not ongoing on the group according to an embodiment of the disclosure; and

FIG. 6 is a sequence diagram that illustrates a procedure for canceling in-progress imminent peril state of a group while a call is not ongoing on the group according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments are described and illustrated in terms of blocks that carry out a described function or functions. These blocks, which are referred to herein as managers, units, modules, hardware components, or the like, are physically implemented by analog and/or digital circuits, such as logic gates, integrated circuits, microprocessors, microcontrollers, memory circuits, passive electronic components, active electronic components, optical components, hardwired circuits, and the like, and may optionally be driven by firmware and software. The circuits, for example, may be embodied in one or more semiconductor chips or on substrate supports, such as printed circuit boards and the like. The circuits constituting a block may be implemented by dedicated hardware or by a processor (e.g., one or more programmed microprocessors and associated circuitry) or by a combination of dedicated hardware to perform some functions of the block and a processor to perform other functions of the block. Each block of the embodiments may be physically separated into two or more interacting and discrete blocks without departing from the scope of the proposed method. Likewise, the blocks of the embodiments may be physically combined into more complex blocks without departing from the scope of the proposed method.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

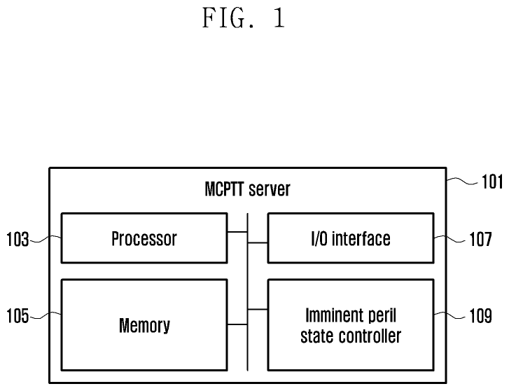

Referring now to the drawings, and more particularly to FIGS. 1 through 6 where similar reference characters denote corresponding features consistently throughout the figures, there are shown preferred embodiments.

FIG. 1 is the block diagram of the MCPTT server for handling in-progress imminent peril state during mission-critical services according to an embodiment of the disclosure.

The MCPTT server 101 provides centralized support for MCPTT services. The MCPTT server 101 can perform the controlling role for private calls and group calls. The MCPTT server 101 performing the controlling role for a private call or group call can also perform the participating role for the same private call or group call. For each private call and group call, there shall be one MCPTT server 101 assuming the controlling role while one or more MCPTT servers 101 in the participating role may be included.

The MCPTT server 101 includes a processor 103, memory 105, an I/O interface 107, and an imminent peril state controller 109. Furthermore, the processor 103 of the MCPTT server 101 communicates with the memory 105, the I/O interface 107, and the imminent peril state controller 109. The processor 103 is configured to execute instructions stored in the memory 105 and to perform various processes. The processor 103 can include one or a plurality of processors, can be a general-purpose processor, such as a central processing unit (CPU), an application processor (AP), or the like, a graphics-only processing unit, such as a graphics processing unit (GPU), a visual processing unit (VPU), and/or an Artificial Intelligence (AI) dedicated processor, such as a neural processing unit (NPU).

Furthermore, the memory 105 of the MCPTT server 101 includes storage locations that can be addressed through the processor 103. The memory 105 is not limited to volatile or non-volatile memory and can include one or more computer-readable storage media. Non-volatile storage elements, such as magnetic hard disks, optical discs, floppy discs, flash memories, EPROM, or EEPROM memories can also be included in the memory 105. Further, the memory 105 of the MCPTT server 101 can store various information received from the MCPTT client. The MCPTT server 101 can store several pieces of information, such as an imminent peril indication in the SIP request message to cancel an in-progress imminent peril state of the MCPTT group and the like.

The I/O interface 107 transmits information between the memory 105 and external peripheral devices, which are input-output devices associated with the MCPTT server 101. The I/O interface 107 receives various information from the network. This interface is used to maintain seamless communication between the MCPTT server 101 and external devices, ensuring that data is transmitted and received. Further, the I/O interface 107 facilitates the integration of the MCPTT server 101 with the MCPTT client for handling in-progress imminent peril state during mission-critical services.

The imminent peril state controller 109 communicates with the I/O interface 107 and the memory 105 for handling in-progress imminent peril state during mission-critical services. The imminent peril state controller 109 is an innovative hardware that is realized through the physical implementation of both analog and digital circuits, including logic gates, integrated circuits, microprocessors, microcontrollers, memory circuits, passive and active electronic components, as well as optical components.

The imminent peril state controller 109 receives the SIP request message from an authorized MCPTT client of a MCPTT group to cancel an in-progress imminent peril state of the MCPTT group. The SIP request message includes the imminent peril indication being set to false, indicating to cancel the in-progress imminent peril state of the MCPTT group. In an embodiment of the disclosure, the SIP request message can include additional parameters, such as the timestamp of the request, the unique identifier of the MCPTT client, the MCPTT group ID whose imminent peril state is being cancelled, and the specific reason for the cancellation. Further, the imminent peril state controller 109 validates the SIP request message and the in-progress imminent peril state of the MCPTT group. The validation process includes checking the authenticity of the request, verifying the credentials of the MCPTT client, and ensuring that the imminent peril state was indeed active. Further, the imminent peril state controller 109 sets the in-progress imminent peril state of the MCPTT group to a value of false to cancel the in-progress imminent peril state of the MCPTT group. This includes updating the state in the controller's database and ensuring that relevant flags and indicators are reset. Further, the imminent peril state controller 109 clears all MCPTT IDs of MCPTT users that triggered the setting of the in-progress imminent peril state of the MCPTT group to “true” when the validation is successful. This step ensures that no residual data or erroneous states remain in the system. Further, the imminent peril state controller 109 transmits the SIP notification message with imminent peril indication set to false to the MCPTT clients of the affiliated members of the MCPTT group, indicating to cancel the in-progress imminent peril state at each MCPTT client and the in-progress imminent peril state of the MCPTT group. In an example, the notification message can include additional information, such as group ID, MCPTT ID of the user who initiated the cancel request, the time of cancellation and any instructions for the MCPTT clients. Further, the imminent peril state controller 109 transmits the response to the SIP request message indicating successful cancellation of the in-progress imminent peril state of the MCPTT group. In an embodiment of the disclosure, the response can include a confirmation code and a summary of the actions taken.

In an embodiment of the disclosure, the imminent peril state controller 109 transmits an error response message to the MCPTT client when the validation is unsuccessful. In an example, the error response message can include details, such as the reason for the failure, error codes, and suggestions for corrective actions. The error response message ensures that the MCPTT client is informed of the issue and can take appropriate steps to resolve it, such as re-submitting the request with correct parameters or contacting support.

In an embodiment of the disclosure, the originating participating MCPTT function associated with the MCPTT server 101 receives the SIP request message to cancel the in-progress imminent peril state of the MCPTT group. The originating participating MCPTT function acts as the initial point of contact for the SIP request and performs preliminary checks before forwarding it. Further, the originating participating MCPTT function transmits or forwards the SIP request message to a controlling MCPTT function associated with the MCPTT server 101. In an example, this forwarding process routes the message through secure channels and ensuring that it reaches the correct destination within the server architecture. In an example, the originating participating MCPTT function can add metadata to the request, such as routing information and timestamps, to facilitate tracking and processing.

In an embodiment of the disclosure, the controlling MCPTT function associated with the MCPTT server 101 receives the SIP request message to cancel the in-progress imminent peril state of the MCPTT group from the originating participating MCPTT function. The controlling MCPTT function is responsible for making the final decision on the request and updating the state of the MCPTT group accordingly. Further, the controlling MCPTT function determines whether the MCPTT user of the MCPTT client is authorized to cancel the in-progress imminent peril state of the MCPTT group. This determination includes checking the user's credentials, permissions, and any relevant policies or rules. The controlling MCPTT function rejects the SIP request message when the received SIP request message is from an unauthorized MCPTT user of the MCPTT client. The rejection process includes sending an error response to the originating function and logging the unauthorized attempt. Further, the controlling MCPTT function sets the in-progress imminent peril state of the MCPTT group to a value of false to cancel the in-progress imminent peril state of the MCPTT group when the MCPTT user of the MCPTT client is authorized. This includes updating the state in the server's database and ensuring that all relevant indicators are reset. Further, the controlling MCPTT function generates the SIP notification message indicating the cancellation of the imminent peril state of the MCPTT group. In an example, the notification message can include additional information, such as the time of cancellation, group ID, MCPTT User ID of the user who requested for the cancellation and any instructions for the MCPTT clients. Further, the controlling MCPTT function transmits the SIP notification message indicating the cancellation of the imminent peril state of the MCPTT group to the terminating participating MCPTT function. This transmission process includes routing the message through secure channels and ensuring that it reaches the correct destination within the server architecture. In an embodiment of the disclosure, the MCPTT clients belong to the affiliated members of the group.

In an embodiment of the disclosure, the terminating participating MCPTT function associated with the MCPTT server 101 receives the SIP notification message indicating the cancellation of the imminent peril state of the MCPTT group. The terminating participating MCPTT function acts as the final point of contact for the notification and performs the necessary actions to update the state of the MCPTT clients. Further, the terminating participating MCPTT function transmits the SIP notification message with imminent peril indication set to false to each of the MCPTT clients of the affiliated members of the MCPTT group, indicating to cancel the in-progress imminent peril state at each MCPTT client and the in-progress imminent peril state of the MCPTT group. The transmission process can route the message through secure channels and ensuring that it reaches the correct destination within the client architecture. In an embodiment of the disclosure, the terminating participating MCPTT function adds metadata to the notification, such as routing information and timestamps, to facilitate tracking and processing.

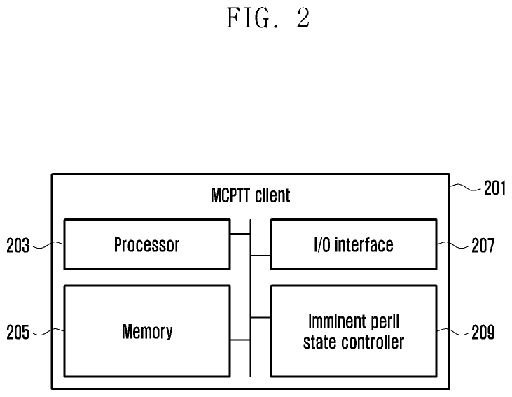

FIG. 2 is a block diagram of the MCPTT client for handling in-progress imminent peril state during mission critical services according to an embodiment of the disclosure.

Referring to FIG. 2, a MCPTT client 201 refers to any device configured to utilize the MCPTT service for communication within a mission-critical network. Examples of the MCPTT client 201 include, but are not limited to, consumer electronics, such as mobile phones and smartphones, tablets, and wearable devices, computing devices, such as laptops, notebooks, desktops, and workstations, Internet of things (IoT) devices, automotive systems, such as connected cars, autonomous vehicles, and devices supporting vehicle-to-everything (V2X) communication, enterprise devices including robotics and specialized equipment, such as medical devices and public safety equipment, and media devices, such as gaming consoles and streaming devices. It is understood that the MCPTT client 201 can include any hardware, or combination of hardware and software capable of interfacing with the MCPTT service and supporting mission-critical communications.

Examples of the telecommunication network system include, but are not limited to, cellular networks (such as second generation (2G), third generation (3G), fourth generation (4G), 5G, Beyond 5G (B5G)/6G, or advanced cellular networks), local area networks (LANs) (such as Wi-Fi, Li-Fi, or the like), personal area networks (PANs) (such as Bluetooth, Zigbee, Z-Wave, or the like), wide area networks (WANs) (such as satellite communication networks, long range wide area network, narrowband IoT, low-bandwidth communication for IoT, or the like), metropolitan area networks (MANs), machine-to-machine (M2M), Ad Hoc and mesh networks, emerging and advanced networks.

The MCPTT client 201 includes a processor 203, memory 205, an I/O interface 207, and an imminent peril state controller 209. Furthermore, the processor 203 of the MCPTT client 201 communicates with the memory 205, the I/O interface 207, and the imminent peril state controller 209. The processor 203 is configured to execute instructions stored in the memory 205 and to perform various processes. The processor 203 can include one or a plurality of processors, can be a general-purpose processor, such as a central processing unit (CPU), an application processor (AP), or the like, a graphics-only processing unit, such as a graphics processing unit (GPU), a visual processing unit (VPU), and/or an Artificial Intelligence (AI) dedicated processor, such as a neural processing unit (NPU).

Furthermore, the memory 205 of the MCPTT client 201 includes storage locations that can be addressed through the processor 203. The memory 205 is not limited to volatile or non-volatile memory and can include one or more computer-readable storage media. Non-volatile storage elements, such as magnetic hard disks, optical discs, floppy discs, flash memories, EPROM, or EEPROM memories can also be included in the memory 205. Further, the memory 205 of the MCPTT client 201 can store various information received from MCPTT server. The MCPTT client 201 can store several pieces of information, such as an imminent peril indication in the SIP request message to cancel an in-progress imminent peril state of the MCPTT group and the like.

The I/O interface 207 is configured to facilitate the transmission of information between the memory 205 and external peripheral devices, which may include various input-output devices associated with the MCPTT client 201. Further, the I/O interface 207 is adapted to receive data from external networks, enabling seamless integration of the MCPTT client 201 with network resources. This interface ensures robust, uninterrupted communication between the MCPTT client 201 and external devices by supporting the bidirectional flow of data. Furthermore, the I/O interface 207 is operable to interface the MCPTT client 201 with the MCPTT server 101 to manage and coordinate the handling of an in-progress imminent peril state during mission-critical operations. By doing so, the I/O interface 207 ensures the reliability and efficiency of mission-critical communication services, addressing real-time operational requirements.

The imminent peril state controller 209 is configured to communicate with the I/O interface 207 and the memory 205 for managing and resolving in-progress imminent peril states during mission-critical services. The imminent peril state controller 209 is a hardware-implemented component, realized through a tangible and physical structure comprising analog and digital circuits. The hardware architecture of the imminent peril state controller 209 incorporates a combination of logic gates, integrated circuits, microprocessors, microcontrollers, memory circuits, and passive electronic components (such as resistors, capacitors, and inductors) as well as active electronic components (such as transistors and diodes). Further, the imminent peril state controller 209 can include optical components where necessary to enhance performance and reliability. This physical implementation ensures that the imminent peril state controller 209 operates as a specific and concrete hardware module, providing a technical solution to efficiently address real-time operational challenges in mission-critical environments.

In an embodiment of the disclosure, the imminent peril state controller 209 generates the SIP request message by setting the in-progress imminent peril state indication to false to cancel the in-progress imminent peril state of the MCPTT group upon receiving a request from an MCPTT user to cancel the in-progress imminent peril state of the MCPTT group. The imminent peril state controller 209 utilizes a predefined protocol to ensure the integrity and authenticity of the SIP request message, incorporating security measures, such as encryption and digital signatures. Further, the imminent peril state controller 209 transmits the SIP request message to an MCPTT server to cancel the in-progress imminent peril state of the MCPTT group. The transmission is carried out over a secure communication channel to prevent unauthorized access or tampering. Further, the imminent peril state controller 209 receives the response to the SIP request message from the MCPTT server, indicating a successful cancellation of the in-progress imminent peril state of the MCPTT group. The response message includes a timestamp and a unique transaction ID to correlate the request and response.

In an embodiment of the disclosure, the response is at least one of a SIP 2XX response, SIP 4xx response, SIP 5xx response, or SIP 6xx response. The SIP 2XX response indicates successful processing of the request, while the SIP 4xx response signifies client-side errors, such as bad request or unauthorized access. The SIP 5xx response denotes server-side errors, including internal server errors or service unavailability, and the SIP 6xx response indicates global failures, such as the call being declined by all possible endpoints. Each response type is accompanied by specific status codes and reason phrases to provide detailed information about the outcome of the request.

In an embodiment of the disclosure, the imminent peril state controller 209 sets the MCPTT imminent peril group state to MIG1 (no imminent peril) when a SIP 2XX response to the SIP request message is received. Further, the imminent peril state controller 209 sets the MCPTT imminent peril group state to MIG2 (in-progress) when one of SIP 4xx response, SIP 5xx response, or SIP 6xx response to the SIP request message is received. In an example, the imminent peril state controller 209 can triggers an alert to notify the MCPTT users of the failure to cancel the imminent peril state, providing them with the specific error code and suggested corrective actions.

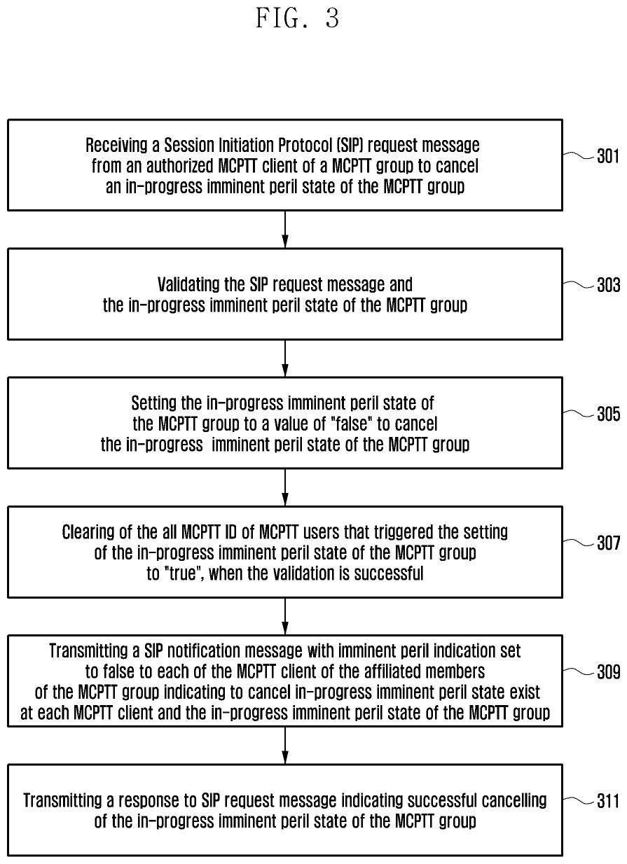

FIG. 3 is a flow diagram that illustrates a method for handling in-progress imminent peril state during mission-critical services by a MCPTT server according to an embodiment of the disclosure.

Referring to FIG. 3, at block 301, the method includes receiving, by the MCPTT server 101, the SIP request message from the authorized MCPTT client 201 of an MCPTT group to cancel an in-progress imminent peril state of the MCPTT group. The SIP request message includes the imminent peril indication being set to false, indicating the intention to cancel the in-progress imminent peril state of the MCPTT group. In an example, the message includes authentication tokens and the MCPTT group ID to verify the legitimacy of the request.

At block 303, the method includes validating, by the MCPTT server 101, the SIP request message and the in-progress imminent peril state of the MCPTT group. In an example, the validation process includes checking the authenticity of the request, ensuring that the requester has the necessary permissions, and verifying the current state of the MCPTT group.

At block 305, the method includes setting, by the MCPTT server 101, the in-progress imminent peril state of the MCPTT group to a value of false to cancel the in-progress imminent peril state of the MCPTT group. This state change is propagated across the network to ensure all relevant systems and users are updated. The server logs this change along with a timestamp and the ID of the user who initiated the request.

At block 307, the method includes clearing, by the MCPTT server 101, all MCPTT IDs of MCPTT users that triggered the setting of the in-progress imminent peril state of the MCPTT group to “true” when the validation is successful. This step ensures that the system resets to a normal state, removing any flags or markers associated with the imminent peril state. The server also sends notifications to the affected users, informing them of the state change.

At block 309, the method includes transmitting, by the MCPTT server 101, the SIP notification message with the imminent peril indication set to false to each of the MCPTT clients of the affiliated members of the MCPTT group, indicating the cancellation of the in-progress imminent peril state at each MCPTT client and the in-progress imminent peril state of the MCPTT group. In an example, the notification message includes detailed information about the state change, the reason for the cancellation and MCPTT group ID.

At block 311, the method includes transmitting, by the MCPTT server 101, the response to the SIP request message, indicating the successful cancellation of the in-progress imminent peril state of the MCPTT group. The response message is sent back to the originating MCPTT client and includes a confirmation code, a timestamp, and any relevant details about the state change.

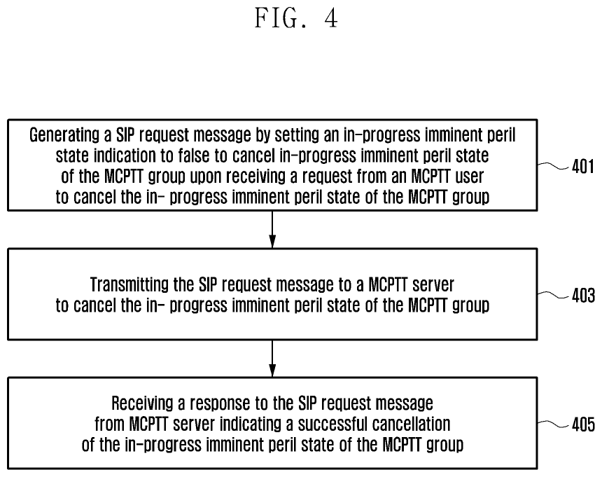

FIG. 4 is a flow diagram that illustrates a method for handling in-progress imminent peril state during mission-critical services by the MCPTT client according to an embodiment of the disclosure.

Referring to FIG. 4, at block 401, the method includes generating, by the MCPTT client 201, the SIP request message by setting an in-progress imminent peril state indication to false to cancel the in-progress imminent peril state of the MCPTT group upon receiving a request from an MCPTT user to cancel the in-progress imminent peril state of the MCPTT group.

At block 403, the method includes transmitting, by the MCPTT client 201, the SIP request message to an MCPTT server 101 to cancel the in-progress imminent peril state of the MCPTT group. The transmission is performed over a secure and reliable communication channel, ensuring that the message reaches the server without any loss or corruption.

At block 405, the method includes receiving, by the MCPTT client 201, the response to the SIP request message from the MCPTT server 101, indicating the successful cancellation of the in-progress imminent peril state of the MCPTT group. The client application processes the response, updates its internal state to reflect the cancellation, and notifies the user of the successful state change.

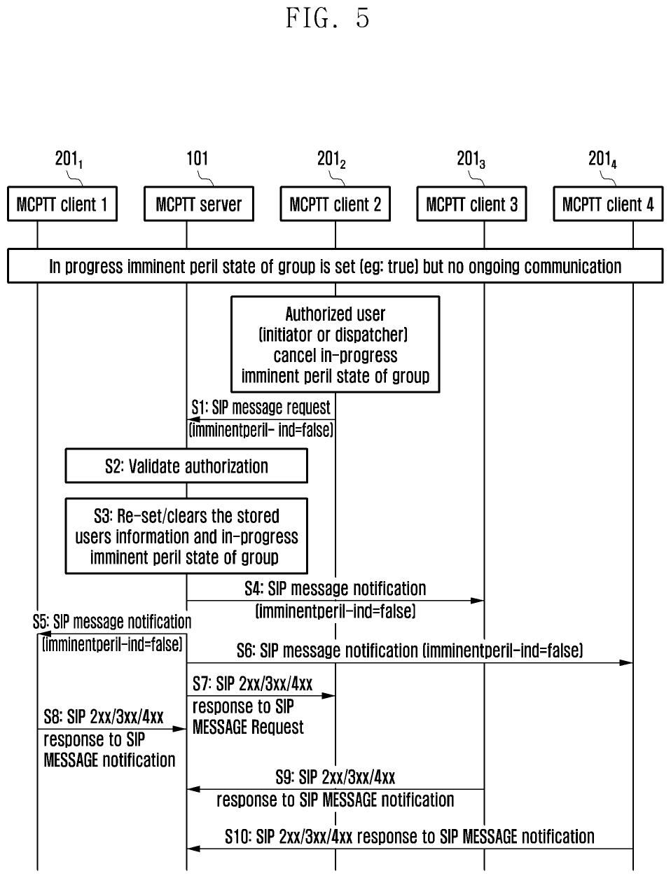

FIG. 5 is a sequence diagram that illustrates a procedure for cancelling in-progress imminent peril state of a group while call is not ongoing on the group, according to an embodiment of the disclosure.

Referring to FIG. 5, consider the MCPTT client 1 201₁, the MCPTT Client 2 201₂, MCPTT Client 3 201₃ and the MCPTT Client 4 201₄ are affiliated to the MCPTT group and previously imminent peril call was successfully completed on the MCPTT group. In addition, consider the user at the MCPTT client 2 201₂ is authorized user to cancel the in-progress imminent peril state of the MCPTT group. In addition, consider the in-progress imminent peril state of group is set and there is no call on a group ongoing.

Further, when the user at the MCPTT client 2 201₂ determines to cancel the in-progress imminent peril state of the MCPTT group, then at operation S1, the MCPTT client 2 201₂ sends the SIP request message to the MCPTT server 101 to cancel the in-progress imminent peril state of the MCPTT group with imminent peril indication being set to false.

Further, at operation S2, the MCPTT server 101 validates the request and the in-progress imminent peril state of the of the MCPTT group. Further, when the authorization is not successful, then the MCPTT server returns the error response message to the MCPTT client 2 201₂.

Further, at operation S3, the MCPTT server 101 re-sets or clears the cached information about MCPTT user(s) of outstanding group imminent peril state and in-progress imminent peril state of the MCPTT group.

Further, when the MCPTT server 101 determines that the outstanding group imminent peril state of the MCPTT user(s) exist and in-progress imminent peril state of the MCPTT group is set, then the MCPTT server 101 shall send the notification to all the affiliated members of the MCPTT group using SIP MESSAGE request with imminent peril indication set to false (i.e., ‘imminentperil-ind’ set to ‘false’). More particularly, in operations S4-S6, the MCPTT server 101 sends the SIP notification message to the MCPPT client 3 201₃, MCPTT client 1 201₁ and the MCPTT client 4 201₄.

Further, at operation S7 the MCPTT server 101, sends a response to the SIP request message to the MCPTT client 2 201₂ indicating the successful cancelation of the in-progress imminent peril state of the MCPTT group.

At operation S8-S10, the MCPTT client 1 201₁, MCPPT client 3 201₃ and the MCPTT client 4 201₄ sends a response to the SIP notification message indicating the successful cancelation of the in-progress imminent peril state of the MCPTT group at each of the MCPTT client 1 201₁, MCPPT client 3 201₃.

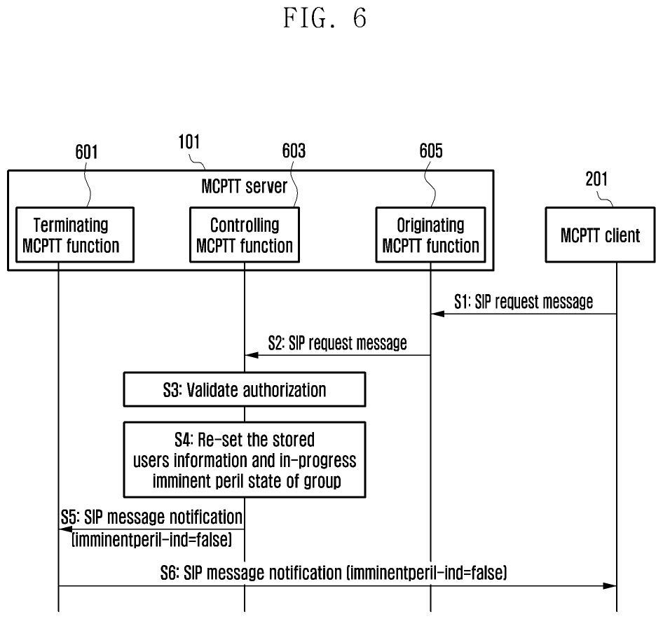

FIG. 6 is a sequence diagram that illustrates the procedure for cancelling in-progress imminent peril state of a group while call is not ongoing on the group, according to an embodiment of the disclosure.

Referring to FIG. 6, the MCPTT server 101 is associated with a terminating MCPTT function 601, a controlling MCPTT function 603 and an originating MCPTT function 605.

At operation S1, the MCPTT client 201 sends the SIP request message to the originating MCPTT function 605 associated with the MCPTT server 101.

At operation S2, the originating MCPTT function 605 sends the SIP request message to the controlling MCPTT function 603 to cancel the in-progress imminent peril state of the of the MCPTT group.

At operation S3, the controlling MCPTT function 603 validates the SIP request message and the in-progress imminent peril state of the of the MCPTT group. Further, when the authorization is not successful, then the controlling MCPTT function 603 returns the error response message to the MCPTT client 201.

Further, at operation S4, the controlling MCPTT function 603 re-sets or clears the cached information about MCPTT user(s) of outstanding group imminent peril state and in-progress imminent peril state of the MCPTT group.

At operation S5, the controlling MCPTT function 603 generates the SIP notification message indicating cancellation of the imminent peril state of the MCPTT group. Further, the controlling MCPTT function 603 transmits the SIP notification message indicating the cancellation of the imminent peril state of the MCPTT group to terminating participating MCPTT function 601.

At operation S6, the terminating MCPTT function 601 sends the SIP notification message indicating the cancellation of the imminent peril state of the MCPTT group to the MCTT client 201.

### 6.2.0.1 SIP MESSAGE Request

The MCPTT client 201 needs to distinguish between specific SIP MESSAGE requests. SIP MESSAGE requests routed to the MCPTT client with the Request-URI set to the public service identity of the MCPTT user and containing a Content-Type header field set to “application/vnd.3gpp.mcptt-info+xml” must be identified. These requests include an XML body containing a<mcpttinfo>root element, which further contains a<mcptt-Params>element that includes an<imminentperil-ind>element. Such requests are referred to as “SIP MESSAGE requests for imminent peril state change notification for terminating MCPTT client” in the procedures described in the disclosure.

According to 3GPP TS 24.379, determining authorization for canceling the in-progress imminent peril state of an MCPTT group includes specific steps. When the MCPTT client 201 receives a request from the MCPTT user to cancel the in-progress imminent peril state of a group, the MCPTT client 201 determines, based on local policy (e.g., if the requester is a dispatcher or initiator of the MCPTT imminent peril group call, or the like), whether to send the in-progress imminent peril state of a group cancel request or not.

In accordance with the 3GPP TS 24.229, the SIP MESSAGE request, the MCPTT server 101 must distinguish between the SIP MESSAGE requests for originations and terminations:
SIP MESSAGE requests routed to the originating participating MCPTT function with the Request-URI set to the public service identity of the participating MCPTT function and containing a Content-Type header field set to “application/vnd.3gpp.mcptt-info+xml” and including an XML body containing a <mepttinfo>root element containing a<mcptt-Params>element containing an <imminentperil-ind>element. Such requests are known as “SIP MESSAGE request for imminent peril state change request for originating participating MCPTT function” in the procedures in the disclosure;
SIP MESSAGE requests routed to the terminating participating MCPTT function with the Request-URI set to the public service identity of the terminating participating MCPTT function and containing a Content-Type header field set to “application/vnd.3gpp.mcptt-info+xml” and including an XML body containing a<mcpttinfo>root element containing a<mcptt-Params>element containing an <imminentperil-ind>element. Such requests are known as “SIP MESSAGE request for imminent peril state change notification for terminating participating MCPTT function” in the procedures in the disclosure; and
SIP MESSAGE requests routed to the controlling MCPTT function with the Request-URI set to the public service identity of the controlling MCPTT function and containing a Content-Type to header field set “application/vnd.3gpp.mcptt-info+xml” and including an XML body containing a <mcpttinfo>root element containing a<mcptt-Params>element containing an <imminentperil-ind>element. Such requests are known as “SIP MESSAGE request for imminent peril state change request for controlling MCPTT function” in the procedures in the disclosure.

In accordance with 3GPP 24.379 clause 6.3.3.1.13 B, the method for determining authorization for canceling the in-progress imminent peril state of an MCPTT group is described. When the controlling MCPTT function 603 receives a SIP request for an MCPTT group with the <imminentperil-ind>element of the application/vnd3gppmcptt-info+xml MIME body set to a value of “false,” it determines whether the in-progress imminent peril state of the group cancel request is authorized. This determination is based on local policy, such as whether the requester is a dispatcher or not the initiator of the MCPTT imminent peril group call that has set the in-progress imminent peril state of the group.

In accordance with 3GPP 24.379 clause 10.1.1.2.1.5, MCPTT in-progress imminent peril cancel. The clause addresses both on-demand sessions and pre-established sessions. Upon receiving a request from an MCPTT user to cancel the in-progress imminent peril condition on a prearranged MCPTT group, the MCPTT client 201 is required to generate a SIP re-INVITE request while in an ongoing prearranged group call. This process must follow the procedures specified in 3GPP TS 24.379 [4], with the clarifications provided below. If the session is not prearranged, the MCPTT client should generate a SIP MESSAGE request by adhering to the client procedure outlined in the 3GPP 24.379 clause 10.1.6.2.1 of the disclosure.

The MCPTT client:
1) if the MCPTT user is not authorized to cancel the in-progress imminent peril group state of the MCPTT group as determined by the procedures of 3GPP 24.379 clause 6.2.8.1.10, the MCPTT client:
   a. should indicate to the MCPTT user that they are not authorized to cancel the in-progress imminent peril group state of the MCPTT group; and
   b. shall skip the remaining steps of the current clause;
2) shall include an application/vnd.3gpp.mcptt-info+xml MIME body populated as specified in clause 3GPP 24.379 6.2.8.1.11; and
3) shall include a Resource-Priority header field and comply with the procedures in clause 3GPP 24.379 6.2.8.1.12;
4) shall include in the application/vnd.3gpp.mcptt-info+xml MIME body with the <mcpttinfo>element containing the <mcptt-Params>element with:
   a. the <session-type>element set to a value of “prearranged”; and
   b. the <mcptt-request-uri>element set to the group identity;
   The MCPTT ID of the originating MCPTT user is not included in the body, as this will be inserted into the body of the SIP re-INVITE request that is sent by the originating participating MCPTT function.
5) shall include the g.3gpp.mcptt media feature tag in the Contact header field of the SIP re-INVITE request according to IETF RFC 3840 [16];
6) if the SIP re-INVITE request is to be sent within an on-demand session, shall include in the SIP re-INVITE request an SDP offer according to 3GPP TS 24.379 [4] with the clarifications specified in clause 3GPP 24.379 clause 6.2.1;
7) if the SIP re-INVITE request is to be sent within a pre-established session, shall include an SDP offer in the SIP re-INVITE request according to 3GPP TS 24.379 [4], based upon the parameters already negotiated for the pre-established session; and
   The SIP re-INVITE request can be sent within an on-demand session or a pre-established session. If the SIP re-INVITE request is sent within a pre-established session, the media-level section for the offered MCPTT speech media stream and the media-level section of the offered media-floor control entity are expected to be the same as was negotiated in the existing pre-established session.
8) shall send the SIP re-INVITE request according to 3GPP TS 24.379 [4].

On receiving a SIP 2xx response to the SIP re-INVITE request, the MCPTT client:
1) shall interact with the user plane as specified in 3GPP TS 24.380 [5];
2) shall set the MCPTT imminent peril group state of the group to “MIG 1: no-imminent-peril”; and
3) shall set the MCPTT imminent peril group call state of the group to “MIGC 1: imminent-peril-gc-capable”.

On receiving a SIP 4xx, SIP 5xx response or SIP 6xx response to the SIP re-INVITE request:
1) if the SIP 4xx response, SIP 5xx response or SIP 6xx response:
   a. contains an application/vnd.3gpp.mcptt-info+xml MIME body with an <imminentperil-ind>element set to a value of “true”; or
   b. does not contain an application/vnd.3gpp.mcptt-info+xml MIME body with an<imminentperil-ind>element;
   then the MCPTT client shall set the MCPTT imminent peril group state as “MIG 2: in-progress”.

This is the case where the MCPTT client 201 requested the cancellation of the MCPTT imminent peril in-progress state and was rejected.

10.1.6 Change of in-progress imminent peril state of the MCPTT group

### General 10.1.6.1

3GPP TS 24.379 Clause 10.1.6 specifies the MCPTT client 201 procedures, participating MCPTT function procedures and controlling MCPTT function 603 procedures for the on-network cancelling of in-progress imminent peril state of the MCPTT group while there is no MCPTT session is ongoing on the MCPTT group.

10.1.6.2 Client procedures

10.1.6.2.1 MCPTT group in-progress imminent peril state cancel initiation.

Upon receiving a request from an MCPTT user to cancel the in-progress imminent peril state on a prearranged MCPTT group on which there is no call ongoing, the MCPTT client 201 shall generate a SIP MESSAGE request in accordance with 3GPP TS 24.379 [4] and IETF RFC 3428 with the clarifications given below.

This SIP MESSAGE request is assumed to be sent out-of-dialog.

The MCPTT client:
1) if the MCPTT user is not authorized to cancel the in-progress imminent peril state of the MCPTT group as determined by the procedures of 3GPP TS 24.379 clause 6.2.8.1.A, the MCPTT client:
   a. should indicate to the MCPTT user that they are not authorized to cancel the in-progress imminent peril state of the MCPTT group; and
   b. shall skip the remaining steps of the current clause;
2) shall include the ICSI value “urn: urn-7: 3gpp-service.ims.icsi.mcptt” (coded as specified in 3GPP TS 24.379 [4]), in a P-Preferred-Service header field according to IETF RFC 6050 [9] in the SIP MESSAGE request;
3) shall include an Accept-Contact header field with the g.3gpp.icsi-ref media feature tag containing the value of “urn: urn-7: 3gpp-service.ims.icsi.mcptt” along with the “require” and “explicit” header field parameters according to IETF RFC 3841 [6];
4) can include a P-Preferred-Identity header field in the SIP MESSAGE request containing the public user identity of the originator as specified in 3GPP TS 24.379 [4];
5) shall include an application/vnd.3gpp.mcptt-info+xml MIME body as specified in clause F.1 with the <mcpttinfo>element containing the <mcptt-Params>element with:
   a. the <mcptt-request-uri>element set to the MCPTT group identity;
   b. the <imminentperil-ind>element set to a value of “false”;
   c. the <mcptt-client-id>element set to the MCPTT client ID of the originating MCPTT client; and
   d. if the MCPTT client needs to include an active functional alias in the SIP MESSAGE request, the <anyExt>element with the <functional-alias-URI>element set to the URI of the used functional alias;
   The MCPTT client learns the functional aliases that are activated for an MCPTT ID from procedures specified in clause 9A.2.1.3.
6) shall set the Request-URI to the public service identity identifying the participating MCPTT function serving the MCPTT user;
7) shall set MCPTT imminent peril group state to “MIG 3: cancel-pending”; and
8) shall send the SIP MESSAGE request according to rules and procedures of 3GPP TS 24.379 [4].

On receiving a SIP 2xx response to the SIP MESSAGE request, the MCPTT client 201 shall set the MCPTT imminent peril group state to “MIG 1: no-imminent peril”.

On receiving a SIP 4xx response a SIP 5xx response or a SIP 6xx response to the SIP MESSAGE request, the MCPTT client 201 shall set the MCPTT imminent peril group state to “MIG 2: in-progress”.

According to 3GPP TS 22.379 clause 10.1.6.2.2, reception of MCPTT group in-progress imminent peril state cancel notification. Upon receiving a “SIP MESSAGE request for imminent peril notification for terminating MCPTT client” for the cancellation of the in-progress imminent peril state of the MCPTT group, the MCPTT client:
1) if the received SIP MESSAGE request contains an application/vnd.3gpp.mcptt-info+xml MIME body with the <imminentperil-ind>element set to a value of “false”:
   a. should display to the MCPTT user an indication of the cancellation of the in-progress imminent peril state of the MCPTT group including the following:
      i. the MCPTT group identity contained in the <mcptt-calling-group-id>element application/vnd.3gpp.mcptt-info+xml MIME body; and
      ii. the <mcptt-calling-user-id>element of the application/vnd.3gpp.mcptt-info+xml MIME body; and
   b. shall set the MCPTT imminent peril group state to “MIG 1: no-imminent-peril”;
2) shall generate a SIP 200 (OK) response according to rules and procedures of 3GPP TS 24.379 [4]; and
3) shall send the SIP 200 (OK) response towards the participating MCPTT function according to rules and procedures of 3GPP TS 24.379 [4].

Upon receipt of a “SIP MESSAGE request for imminent peril state change request for originating participating MCPTT function”, the participating MCPTT function:
1) if unable to process the request due to a lack of resources or a risk of congestion exists, may reject the SIP MESSAGE request with a SIP 500 (Server Internal Error) response. The participating MCPTT function can include a Retry-After header field to the SIP 500 (Server Internal Error) response as specified in IETF RFC 3261 and skip the rest of the steps;
2) shall determine the MCPTT ID of the calling user from the public user identity in the P-Asserted-Identity header field of the SIP MESSAGE request;
The MCPTT ID of the calling user is bound to the public user identity at the time of service authorization, as documented in clause 7.3.
3) if the participating MCPTT function cannot find a binding between the public user identity and an MCPTT ID or if the validity period of an existing binding has expired, then the participating MCPTT function shall reject the SIP MESSAGE request with a SIP 404 (Not Found) response with the warning text set to “141 user unknown to the participating function” in a Warning header field as specified in clause 4.4, and shall not continue with any of the remaining steps;
4) if the MCPTT user is not affiliated with the MCPTT group as determined by clause 9.2.2.2.11, shall reject the SIP MESSAGE request with a SIP 403 (Forbidden) response to the SIP MESSAGE request as specified in 3GPP TS 24.379 [4];
5) shall determine the public service identity of the controlling MCPTT function associated with the group identity contained in the <mcptt-request-uri>element contained in the application/vnd.3gpp.mcptt-info+xml MIME body;
The public service identity can identify the controlling MCPTT function in the primary MCPTT system or in a partner MCPTT system.

If the controlling MCPTT function is in a partner MCPTT system in a different trust domain, then the public service identity can identify the MCPTT gateway server that acts as an entry point in the partner MCPTT system from the primary MCPTT system.

If the controlling MCPTT function is in a partner MCPTT system in a different trust domain, then the primary MCPTT system can route the SIP request through an MCPTT gateway server that acts as an exit point from the primary MCPTT system to the partner MCPTT system.

How the participating MCPTT function determines the public service identity of the controlling MCPTT function associated with the group identity or of the MCPTT gateway server in the partner MCPTT system is out of the scope of the disclosure.

How the primary MCPTT system routes the SIP request through an exit MCPTT gateway server is out of the scope of the disclosure.
6) shall generate a SIP MESSAGE request in accordance with 3GPP TS 24.379 [4] and IETF RFC 3428 [33];
7) shall set the Request-URI of the outgoing SIP MESSAGE request to the public service identity of the controlling MCPTT function determined in step 5);
8) shall copy the contents of the application/vnd.3gpp.mcptt-info+xml MIME body in the received SIP MESSAGE request into an application/vnd.3gpp.mcptt-info+xml MIME body as specified in clause F.1 included in the outgoing SIP MESSAGE request;
9) shall set the <mcptt-calling-user-id>contained in <mcptt-Params>element of the application/vnd.3gpp.mcptt-info+xml MIME body to the MCPTT ID determined in step 2) above;
10) shall include a P-Asserted-Identity header field in the outgoing SIP MESSAGE request set to the public service identity of the participating MCPTT function;
11) shall include an Accept-Contact header field containing the g.3gpp.mcptt media feature tag along with the “require” and “explicit” header field parameters according to IETF RFC 3841 [6];
12) shall include an Accept-Contact header field with the media feature tag g.3gpp.icsi-ref with the value of “urn: urn-7: 3gpp-service.ims.icsi.mcptt” along with parameters “require” and “explicit” according to IETF RFC 3841 [6];
13) shall include the ICSI value “urn: urn-7: 3gpp-service.ims.icsi.mcptt” (coded as specified in 3GPP TS 24.379 [4]), into the P-Asserted-Service header field of the outgoing SIP MESSAGE request; and
14) shall send the SIP MESSAGE request towards the controlling MCPTT function as specified to 3GPP TS 24.379 [4].

Upon receipt of a SIP 2xx response in response to the SIP MESSAGE request sent above:
1) shall generate a SIP 200 (OK) response as specified in 3GPP TS 24.379 [4] with the follow clarifications:
   a. shall include a P-Asserted-Identity header field in the outgoing SIP 200 (OK) response set to the public service identity of the participating MCPTT function; and
2) shall send the SIP 200 (OK) response to the MCPTT client according to 3GPP TS 24.379 [4].

Upon receipt of a SIP 4xx, 5xx or 6xx response to the SIP MESSAGE request, shall forward the error response to the MCPTT client 201.

Upon receipt of a “SIP MESSAGE request for imminent peril state change notification for terminating participating MCPTT function”, the participating MCPTT function:
1) if unable to process the request due to a lack of resources or a risk of congestion exists, may reject the SIP MESSAGE request with a SIP 500 (Server Internal Error) response. The participating MCPTT function can include a Retry-After header field to the SIP 500 (Server Internal Error) response as specified in IETF RFC 3261 and skip the rest of the steps;
2) shall use the MCPTT ID present in the <mcptt-request-uri>element of the application/vnd.3gpp.mcptt-info+xml MIME body of the incoming SIP MESSAGE request to retrieve the binding between the MCPTT ID and public user identity;
3) if the binding between the MCPTT ID and public user identity does not exist, then the participating MCPTT function shall reject the SIP MESSAGE request with a SIP 404 (Not Found) response. Otherwise, continue with the rest of the steps;
4) shall generate an outgoing SIP MESSAGE request as specified in 3GPP TS 24.379 clause 6.3.2.2.11;
5) shall include the ICSI value “urn: urn-7: 3gpp-service.ims.icsi.mcptt” (coded as specified in 3GPP TS 24.379 [4]), into the P-Asserted-Service header field of the outgoing SIP MESSAGE request; and
6) shall send the SIP MESSAGE request towards MCPTT client as specified in 3GPP TS 24.379 [4].

Upon receipt of a SIP 2xx response in response to the SIP MESSAGE request sent above:
1) shall generate a SIP 200 (OK) response as specified in 3GPP TS 24.379 [4]; and
2) shall send the SIP 200 (OK) response to the controlling MCPTT function according to 3GPP TS 24.379 [4].

Upon receipt of a SIP 4xx, 5xx or 6xx response to the SIP MESSAGE request, shall forward the response to the controlling MCPTT function.

10.1.6.4 Controlling MCPTT function procedures

### 10.1.6.4.1 Terminating Procedures

10.1.6.4.1.1 Reception of MCPTT group in-progress imminent peril state cancel initiation

Upon receipt of a “SIP MESSAGE request for imminent peril state change request for controlling MCPTT function”, the controlling MCPTT function:
1) if unable to process the request due to a lack of resources or a risk of congestion exists, may reject the SIP MESSAGE request with a SIP 500 (server internal error) response. The controlling MCPTT function can include a retry-after header field to the SIP 500 (server internal error) response as specified in IETF RFC 3261 [24]. Otherwise, continue with the rest of the steps;
2) shall reject the SIP request with a SIP 403 (Forbidden) response and not process the remaining steps if an Accept-Contact header field does not include the g.3gpp.icsi-ref media feature tag containing the value of “urn: urn-7: 3gpp-service.ims.icsi.mcptt”;
3) if the received SIP MESSAGE request is an unauthorized request for an MCPTT in-progress imminent peril state of group cancellation as specified in clause 6.3.3.1.13.B, shall reject the SIP MESSAGE request with a SIP 403 (Forbidden) response to the SIP MESSAGE request as specified in 3GPP TS 24.379 [4];
4) set the in-progress imminent peril state of the MCPTT group to a value of “false”;
5) cache the information that the MCPTT user has cancelled the outstanding in-progress imminent peril state of the group and clear the cache of the all MCPTT ID of the MCPTT users that triggered the setting of the in-progress imminent peril state of the MCPTT group to “true”;
6) for each of the affiliated members of the group shall:
   a. generate a SIP MESSAGE request notification of the cancellation of the MCPTT user's imminent peril call as specified in clause 6.3.3.1.11;
   b. set the <mcptt-calling-user-id>element of the application/vnd.3gpp.mcptt-info+xml MIME body to a value of the <mcptt-calling-user-id>element in the received SIP MESSAGE request;
   c. set the <imminentperil-ind>element of the application/vnd.3gpp.mcptt-info+xml MIME body to a value of “false”; and
   d. send the SIP MESSAGE request towards the terminating participating MCPTT function according to 3GPP TS 24.379 [4];
7) shall generate a SIP 200 (OK) response to the received SIP MESSAGE request as specified in 3GPP TS 24.379 [4]; and
8) shall send the SIP 200 (OK) response towards the originating participating MCPTT function to the received SIP MESSAGE as specified in 3GPP TS 24.379 [4].

Upon receipt of a SIP 2xx, SIP 4xx, 5xx or 6xx responses to the outgoing SIP MESSAGE requests, the controlling MCPTT function shall follow the procedures specified in 3GPP TS 24.379 [4].

G.7 MCPTT imminent peril group state: The MCPTT imminent peril group state is the MCPTT client's perspective of the in-progress imminent peril group state which is managed by the controlling MCPTT function 603. The MCPTT imminent peril group (MIG) state is managed by the MCPTT client 201 to enable the requesting of MCPTT imminent peril-level priority as early as possible in the origination of an MCPTT imminent peril group call. High-level characteristics of this state are captured in Table G.7-1.

TABLE G.7-1
MCPTT imminent peril group state

| MCPTT | | |
|---|---|---|
| imminent | | |
| peril group | | |
| state values | State-entering events | Comments |
| MIG 1: no- | initial state prior to any call | |
| imminent | activity | |
| peril | Imminent peril group call | |
| | cancel request received on | |
| | behalf of another user from | |
| | the MCPTT server | |
| | Imminent peril group call | |
| | cancel response (success) | |
| | in response to initiator's | |
| | request | |
| | MCPTT group in- | |
| | progress imminent peril | |
| | state cancel notification | |
| | received from the | |
| | MCPTT server | |
| | MCPTT group in- | |
| | progress imminent peril | |
| | state cancel response | |
| | (success) in response to | |
| | initiator's request | |
| MIG 2: in- | Imminent peril group call | In this state, all |
| progress | response received | participants in calls on |
| | (confirm) to initiator's | this group will receive |
| | imminent peril group call | imminent peril level |
| | request | priority whether or |
| | Imminent peril group call | not they initiated an |
| | request received (on behalf | MCPTT imminent |
| | of another user) | peril group call |
| | | themselves. |
| MIG 3: | Imminent peril group call | The controlling |
| cancel- | cancel request sent by | MCPTT server may |
| pending | initiator | not grant the cancel |
| | MCPTT group in- | request for various |
| | progress imminent peril | reasons, e.g., other |
| | state cancel request sent | users in an MCPTT |
| | by initiator | imminent peril state |
| | | remain in the call. |
| MIG 4: | Imminent peril group call | The controlling |
| confirm- | request sent by initiator | MCPTT server may |
| pending | | not grant the call |
| | | request for various |
| | | reasons, e.g., the |
| | | MCPTT group is not |
| | | configured as being |
| | | imminent peril- |
| | | capable so it can't be |
| | | assumed that the |
| | | group will enter the |
| | | in-progress state. |

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a mission critical push to talk (MCPTT) server for handling in-progress imminent peril state in a communication system, the method comprising:
receiving a session initiation protocol (SIP) request message transmitted from an MCPTT client of an MCPTT group to cancel an in-progress imminent peril state of the MCPTT group, wherein the SIP request message includes an imminent peril indication being set to false;
setting the in-progress imminent peril state of the MCPTT group to a value of false;
clearing all MCPTT identification (ID) of MCPTT users that triggered the setting of the in-progress imminent peril state of the MCPTT group to true;
transmitting a SIP notification message including an imminent peril indication set to false for each of affiliated members of the MCPTT group; and
transmitting a response to the SIP request message.

2. The method of claim 1,
wherein the receiving of the SIP request message comprises:
determining whether the SIP request message is authorized, and
in case that the SIP request message is an unauthorized request for cancelling of the in-progress imminent peril state of the MCPTT group, rejecting the SIP request message, and
wherein one or more MCPTT clients are the affiliated members of the MCPTT group.

3. The method of claim 1, wherein the transmitting of the SIP notification message further comprises:
generating the SIP notification message indicating cancellation of an imminent peril state of the MCPTT users; and
transmitting the SIP notification message to a terminating participating MCPTT function associated with the MCPTT server.

4. The method of claim 3, further comprising:
transmitting, by the terminating participating MCPTT function, the SIP notification message including the imminent peril indication set to false to the MCPTT client,
wherein, in case that the SIP request message is transmitted from an unauthorized MCPTT user, the SIP request message is rejected.

5. A method performed by a mission critical push to talk (MCPTT) client for handling in-progress imminent peril state in a communication system, the method comprising:
generating a session initiation protocol (SIP) request message including an in-progress imminent peril state indication set to false to cancel in-progress imminent peril state of an MCPTT group upon receiving a request from an MCPTT user to cancel the in-progress imminent peril state of the MCPTT group;
transmitting, to an MCPTT server, the SIP request message to cancel the in-progress imminent peril state of the MCPTT group; and
receiving, from the MCPTT server, a response to the SIP request message.

6. The method of claim 5, wherein the response includes at least one of a SIP 2XX response, SIP 4xx response, SIP 5xx response or SIP 6xx response.

7. The method of claim 5, further comprising:
setting an MCPTT imminent peril group state to MIG1: no imminent peril, in case that a SIP 2XX response to the SIP request message is received; or
setting the MCPTT imminent peril group state to MIG2: in-progress, in case that one of SIP 4xx response, SIP 5xx response or SIP 6xx response to the SIP request message is received.

8. The method of claim 5, wherein, in case that the SIP request message is transmitted from an unauthorized MCPTT user, the SIP request message is rejected.

9. A mission critical push to talk (MCPTT) server for handling in-progress imminent peril state in a communication system, the MCPTT server comprising:
a processor configured to:
receive a session initiation protocol (SIP) request message transmitted from an MCPTT client of a MCPTT group to cancel an in-progress imminent peril state of the MCPTT group, wherein the SIP request message includes an imminent peril indication being set to false,
set the in-progress imminent peril state of the MCPTT group to a value of false,
clear of all MCPTT identification (ID) of MCPTT users that triggered the setting of the in-progress imminent peril state of the MCPTT group to true,
transmit a SIP notification message including an imminent peril indication set to false for each of affiliated members of the MCPTT group, and
transmit a response to the SIP request message.

10. The MCPTT server of claim 9,
wherein the processor is further configured to:
determine whether the SIP request message is authorized, and
in case that the SIP request message is an unauthorized request for cancelling of the in-progress imminent peril state of the MCPTT group, reject the SIP request message, and
wherein one or more MCPTT clients are the affiliated members of the MCPTT group.

11. The MCPTT server of claim 9, wherein the processor is further
generate the SIP notification message indicating cancellation of an imminent peril state of the MCPTT users, and
transmit the SIP notification message to a terminating participating MCPTT function associated with the MCPTT server.

12. The MCPTT server of claim 9,
wherein the processor is further configured to transmit the SIP notification message including the imminent peril indication set to false to the MCPTT client, and
wherein, in case that the SIP request message is transmitted from an unauthorized MCPTT user, the SIP request message is rejected.

13. A mission critical push to talk (MCPTT) client for handling in-progress imminent peril state in a communication system, the MCPTT client comprising:
a processor configured to:
generate a session initiation protocol (SIP) request message including an in-progress imminent peril state indication set to false to cancel in-progress imminent peril state of an MCPTT group upon receiving a request from an MCPTT user to cancel the in-progress imminent peril state of the MCPTT group,
transmit, to an MCPTT server, the SIP request message to cancel the in-progress imminent peril state of the MCPTT group, and
receive, from the MCPTT server, a response to the SIP request message.

14. The MCPTT client of claim 13,
wherein the response includes at least one of a SIP 2XX response, SIP 4xx response, SIP 5xx response or SIP 6xx response, and
wherein, in case that the SIP request message is transmitted from an unauthorized MCPTT user, the SIP request message is rejected.

15. The MCPTT client of claim 13, wherein the processor is further
set an MCPTT imminent peril group state to MIG1: no imminent peril, in case that a SIP 2XX response to the SIP request message is received, or
set the MCPTT imminent peril group state to MIG2: in-progress, in case that one of SIP 4xx response, SIP 5xx response or SIP 6xx response to the SIP request message is received.
